(19) United States
(12) Patent Application Publication
(10) Pub. No.: US 2008/0297767 A1
(43) Pub. Date: Dec. 4, 2008

(54) Reducing exposure risk in ultraviolet light-based electro-optical systems

(76) Inventors: David P. Goren, Smithtown, NY (US); Robert Grant, Coram, NY (US); Christopher Warren Brock, Manorville, NY (US); Thomas D. Bianculli, Manorville, NY (US); Thomas Boehm, Medford, NY (US)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/807,944

(22) Filed: May 30, 2007

(51) Int. Cl. G01J 3/00

(52) U.S. Cl. 356/51

(57) ABSTRACT

In an electro-optical system for reading ultraviolet (UV) light-responsive indicia illuminated by a UV light beam having a wavelength shorter than visible light, safety techniques are described for reducing exposure to the UV light beam to within safe limits.

### BACKGROUND OF THE INVENTION

1. Field of the Invention

The present invention generally relates to ultraviolet light-based electro-optical systems for reading indicia, for example, bar code symbols that fluoresce or reflect when exposed to ultraviolet light and, in particular, to an arrangement for, and a method of, reducing the risk of ultraviolet light exposure for increased safety in such systems.

2. Description of the Related Art

Various electro-optical readers have previously been developed for reading bar code symbols appearing on a label, or on a surface of a target. The bar code symbol itself is a coded pattern of indicia having bars and spaces of different light reflectivity. Generally, the readers electro-optically transform graphic indicia of the symbols into electrical signals that are decoded into alphanumeric characters. The resulting characters describe the target and/or some characteristic of the target with which the symbol is associated. Such characters typically comprise input data to a data processing system for applications in point-of-sale processing, inventory control, article tracking and the like.

Electro-optical readers have been disclosed, for example, in U.S. Pat. No. 4,251,798; No. 4,369,361; No. 4,387,297; No. 4,409,470, No. 4,760,248 and No. 4,896,026, all of which have been assigned to the assignee of the present invention. These readers generally include a light source consisting of a gas laser or semiconductor laser for emitting a light beam. The laser beam is optically modified, typically by a focusing optical assembly, to form a beam spot having a certain size at a predetermined target location. The focused light beam is directed by a scan component along a light path toward a target symbol. The reader operates by repetitively scanning the light beam in a scan pattern, for example, a line or a series of lines across the target symbol by movement of the scan component such as a mirror disposed in the path of the light beam. The scan component may sweep the beam spot across the symbol, trace a scan line across and beyond the boundaries of the symbol, and/or scan a predetermined field of view.

Such readers also include a sensor or photodetector that functions to detect light reflected or scattered from the symbol. The photodetector or sensor is positioned in the reader in an optical path so that it has a field of view that extends at least across and slightly beyond the boundaries of the symbol. A portion of the light beam reflected from the symbol is detected and converted into an analog electrical signal. A digitizer digitizes the analog signal. The digitized signal from the digitizer is then decoded, based upon the specific symbology used for the symbol.

Symbols can also be read by employing imagers. For example, an imager may be employed which has a one- or two-dimensional array of cells or photosensors that correspond to image elements or pixels in a field of view of the device. Such an image sensor device may include a two-dimensional or area charge coupled device (CCD) or a complementary metal oxide semiconductor (CMOS) device for capturing light scattered from the symbol, and associated circuits for producing electronic signals corresponding to a two-dimensional array of pixel information over the field of view.

It is therefore known to use a CCD for capturing a monochrome image of a bar code symbol to be read as, for example, disclosed in U.S. Pat. No. 5,703,349. It is also known to use a CCD with multiple buried channels for capturing a full color image of a target as, for example, disclosed in U.S. Pat. No. 4,613,895.

Many applications call for a hand-held reader in which the reader or the imager is accommodated. For such applications, the arrangement of electro-optical components must be compact in order to be accommodated in a hand-held package that may be pistol-shaped. Moreover, such readers must be lightweight and structurally robust to withstand physical shock resulting from rough handling. It is also desirable that minimal power be consumed during operation to extend battery life.

When the symbol is used to identify a product, it has been proposed to print the symbol or a marking on the product with ultraviolet (UV) light-responsive properties to reduce forgeries. Two examples of UV light-responsive properties are the property of reflecting UV light and the property of fluorescing upon exposure to UV wavelengths. Fluorescence is the property of emitting electromagnetic radiation (e.g., visible light) resulting from and occurring only during the absorption of radiation from another source (e.g., UV light). UV light is non-ionizing radiation in the 180 to 405 nanometer wavelength region of the electromagnetic spectrum.

As advantageous as these UV light-responsive indicia are in reducing forgeries, when a UV light source is incorporated in a hand-held reader, there are safety issues that arise. UV light exposure to people, especially operators and consumers in a retail environment, must be kept within safe limits. Unfortunately, there are no immediate warning symptoms to indicate overexposure, and overexposure can cause injury in as brief a time as three seconds. Symptoms of overexposure include varying degrees of skin burning and injury, leading in chronic cases to premature skin aging, wrinkles and skin cancer, as well as cornea inflammation and eye injury, leading in chronic cases to the formation of cataracts. Equipment manufacturers place caution labels on their UV light-emitting equipment, but many individuals still do not know of the hazards associated with UV radiation exposure.

### SUMMARY OF THE INVENTION

One feature of this invention resides, briefly stated, in an arrangement for, and a method of, electro-optically reading ultraviolet (UV) light-responsive indicia, such as one-and/or two-dimensional bar code symbols, or markings, applied to a target. UV light is non-ionizing radiation in the 180 to 405 nanometer wavelength region of the electromagnetic spectrum. Two examples of UV light-responsive properties for the indicia are the property of reflecting UV light and the property of fluorescing upon exposure to UV wavelengths. Fluorescence is the property of emitting electromagnetic radiation (e.g., visible light) resulting from and occurring only during the absorption of radiation from another source (e.g., UV light). A UV light source, such as a UV light emitting diode, a UV laser, or a mercury vapor lamp, generates a UV light beam having a wavelength shorter than visible light, and illuminates the UV light-responsive indicia. A detector detects light returning from the UV light-responsive indicia, and generates an electrical signal indicative of the UV light-responsive indicia.

In accordance with this invention, safety means are provided for reducing exposure to the UV light beam to within safe limits. Such safety means advantageously comprise means, such as a tilt sensor or an accelerometer, for determining an orientation of a housing in which the UV light source and the detector are supported, and a controller operatively connected to the UV light source for enabling the UV light source to generate the UV light only when the orientation is within a predetermined range of orientations, especially when the UV light beam is aimed at the indicia to be read.

The safety means may comprise an optical filter for filtering the UV light beam to block harmful wavelengths of the UV spectrum, especially below 400 nanometers, or a shroud around the UV light source for blocking some of the UV light beam, but allowing visible light to pass to aid in aiming.

The safety means may also comprise means for determining whether the indicia responded to the UV light beam, and a controller operatively connected to the UV light source for energizing the UV light source at a low duty cycle when the indicia has not responded to the UV light beam, and at a high duty cycle when the indicia has responded to the UV light beam. The determining means preferably comprises a visible light source operative for illuminating the UV light-responsive indicia with a visible light beam, and means for comparing the visible light beam and the UV light beam returning from the UV light-responsive indicia.

In another embodiment of the safety means, the controller is operatively connected to the UV light source, and determines whether the UV light-responsive indicia was successfully read, and deenergizes the UV light source upon a determination that the UV light-responsive indicia was not successfully read for a predetermined period of time. In addition, the controller may be operatively connected to a host, and energizes the UV light source only upon a command generated by the host to increase safety. One or more of the above-described safety measures may be utilized in a UV light-based electro-optical system.

One such UV light-based electro-optical system is a reader that includes a scanner for sweeping the UV light beam across the UV light-responsive indicia, and a photodiode having a field of view and acting as the detector. The scanner can also scan the field of view.

Another such UV light-based electro-optical system is an imager in which the detector is an imaging array of photosensors, such as a two-dimensional or area charge coupled device (CCD) or a complementary metal oxide semiconductor (CMOS) device, operative for capturing light returning from the UV light-responsive indicia, and in which the UV light source acts as an illuminator for the array.

For either system, the light returning from the UV light-responsive indicia may have the same wavelength as the UV light beam due to reflection from the UV light-responsive indicia, or may have a different wavelength as the UV light beam due to fluorescence by the UV light-responsive indicia. Inks that fluoresce in the visible spectrum under UV light are known in the art, e.g., inks used for making so-called “black light” posters, and any of these inks can be used for making bar code symbols or markings to be read by either system. Further, some UV fluorescent inks are transparent and non-fluorescing to visible light, thus allowing a bar code symbol or marking to be provided which is invisible to human sight under normal lighting conditions. Such invisible bar code symbols could be used where a normal (i.e., human visible) bar code symbol is undesirable, either for appearance or for security reasons.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic diagram of a UV light-based hand-held reader for reading a bar code symbol in accordance with this invention; and

FIG. 2 is a schematic diagram of a UV light-based portable imager for reading a bar code symbol in accordance with this invention.

### DETAILED DESCRIPTION OF THE PREFERRED EMBODIMENTS

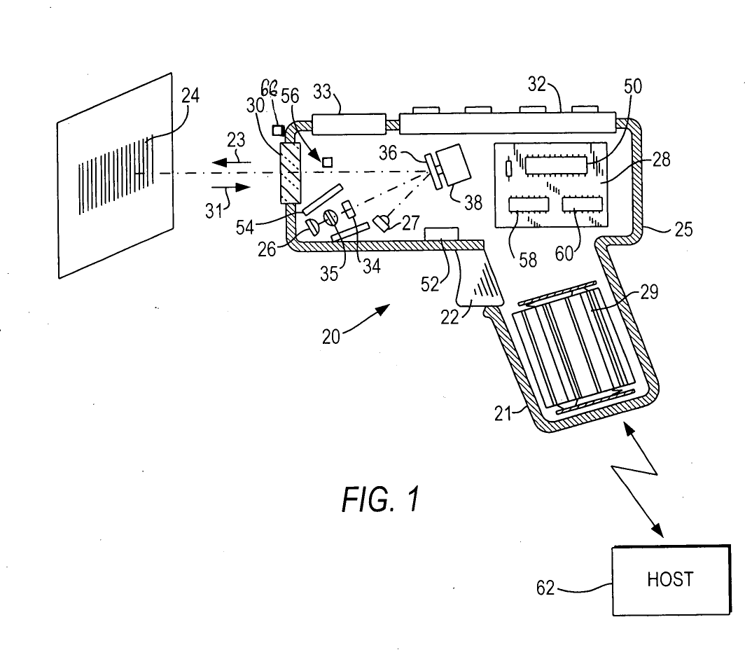

Reference numeral 20 in FIG. 1 generally identifies a hand-held reader for electro-optically reading indicia, such as bar code symbol 24, or other marking, located in a range of working distances therefrom. The indicia is printed on a label or target with an ink that is responsive to ultraviolet (UV) light that lies in the 180 to 405 nanometer wavelength region of the electromagnetic spectrum. The ink has the property of either reflecting the UV light incident thereon, or fluorescing as visible light upon exposure to the UV light.

The reader 20 has a pistol grip handle 21 and a manually actuatable trigger 22 which, when depressed, enables a UV light beam 23 to be directed at the symbol 24. The reader 20 includes a housing 25 in which a UV light source 26, a light detector 27, signal processing circuitry 28, and a battery pack 29 are accommodated. A light-transmissive window 30 at a front of the housing enables the UV light beam 23 to exit the housing, and allows light 31 (either UV light or visible light) scattered off the symbol to enter the housing. A keyboard 32 and a display 33 may advantageously be provided on a top wall of the housing for ready access thereto.

In use, an operator holding the handle 21 aims the housing at the symbol and depresses the trigger. The UV light source 26 emits the UV light beam 23 which is optically modified and focused by an optical focusing assembly 35 to form a beam spot on the symbol 24. The beam passes through an optical filter 34 to a scan mirror 36 which is repetitively oscillated at a scan rate of at least 20 scans a second by a motor drive 38. The scan mirror 36 reflects the beam incident thereon to the symbol 24 and sweeps the beam spot across the symbol in a scan pattern. The scan pattern can be a line extending lengthwise along the symbol along a scan direction, or a series of lines arranged along mutually orthogonal directions, or an omnidirectional pattern, just to name a few possibilities.

The reflected light 31 has a variable intensity over the scan pattern and passes through the window 30 onto the scan mirror 36 where it is reflected onto the photodetector 27 for conversion to an analog electrical signal. As known in the art, the signal processing circuitry 28 including a microprocessor or controller 50 digitizes and decodes the signal to extract the data encoded in the symbol.

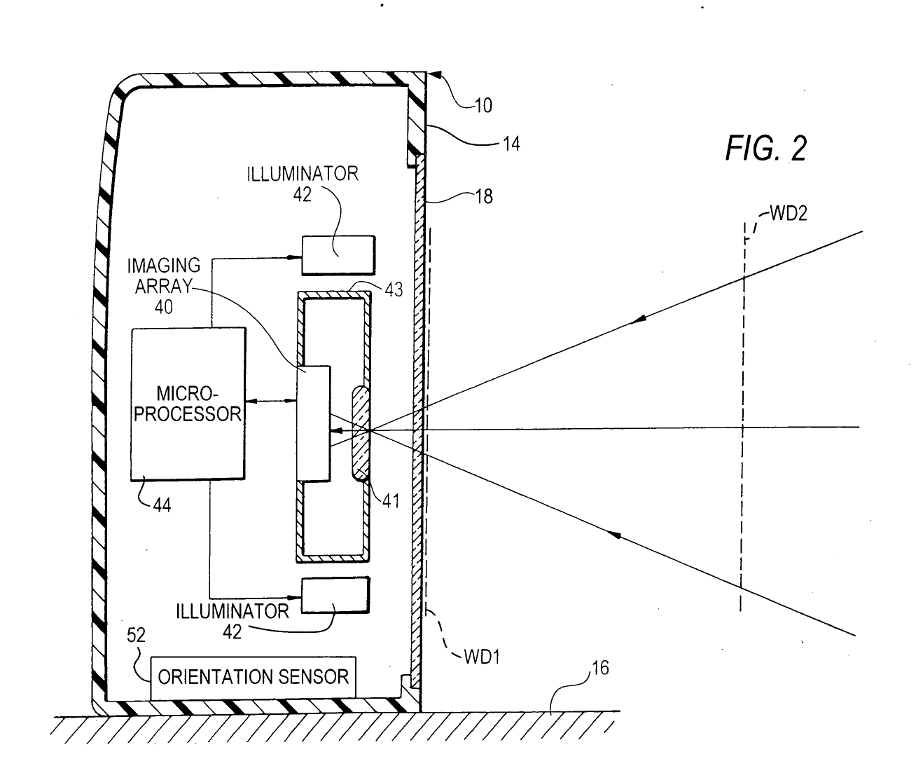

Reference numeral 10 in FIG. 2 generally identifies a portable imager for electro-optically reading UV light-responsive indicia, such as the bar code symbol 24, or other marking. The imager 10 includes an imaging array 40 and an imaging lens assembly 41 mounted in an enclosure 43. The array 40 is a solid-state device, for example, a CCD or a CMOS imager and has a multitude of addressable image sensors operative for capturing light through a window 18 from the symbol over a field of view and located in a working range of distances between a close-in working distance (WD1) and a far-out working distance (WD2). The window 18 is mounted on a housing 14 that rests on a generally planar support surface 16 in a hands-free mode of operation. The housing 14 may be lifted off the surface 16 and held in one's hand during a hand-held mode of operation. In a preferred embodiment, WD1 is about two inches from the array 40 and generally coincides with the window 18, and WD2 is about eight inches from the window 18. An illuminator 42 is also mounted in the imager 10 and preferably includes a mercury vapor lamp or a plurality of UV light sources, e.g., UV light emitting diodes (LEDs), or a UV laser, arranged at opposite sides of the array 40 to uniformly illuminate the symbol 24.

As also shown in FIG. 2, the array 40 and the illuminator LEDs 42 are operatively connected to a controller or microprocessor 44 operative for controlling the operation of these components. Preferably, the microprocessor is the same as the one used for decoding light scattered from the indicia and for processing the captured target images. In operation, the microprocessor 44 sends a command signal to pulse the illuminator LEDs 42 for a short time period, say 500 microseconds or less, and energizes the array 40 to collect light from a target symbol only during said time period. A typical array needs about 33 milliseconds to read the entire target image and operates at a frame rate of about 30 frames per second. The array may have on the order of one million addressable image sensors.

In accordance with this invention, safety means are provided for reducing exposure to the UV light beam generated by either the UV light source 26 of FIG. 1 or the UV light sources 42 of FIG. 2 to within safe limits. The light returning from the symbol 24 is detected by either the photodetector 27 of FIG. 1 or the array 40 of FIG. 2. Such safety means advantageously comprise an orientation sensor 52, such as a tilt sensor or an accelerometer, for determining an orientation of the housings 25, 14 in which the UV light sources 26, 42 and the detectors 27,40 are supported. The controllers 50, 44 are operatively connected to the UV light sources 26, 42 for enabling the UV light sources to generate the UV light only when the orientation is within a predetermined range of orientations. For example, in FIG. 2, the UV light is only generated when the housing 14 is resting on the surface 16 when the orientation sensor 52 is horizontal.

The safety means may also comprise the optical filter 34 configured with a sharp cutoff for filtering the UV light beam to block harmful wavelengths of the UV spectrum. UV light is commonly divided into three regions: UVA or black light having wavelengths in a range of 315-405 nanometers, UVB or erythemal light having wavelengths in a range of 280-314 nanometers, and UVC or germicidal light having wavelengths in a range of 180-279 nanometers. The optical filter 34 advantageously blocks the more harmful UVB and UVC wavelengths below 400 nanometers.

The safety means may also comprise a shroud 54 around the UV light source for blocking some of the UV light beam, especially rays traveling to the side and not towards the symbol 24. The shroud 54 is preferably clear to allow visible light to pass, thereby aiding aiming of the housing at the indicia.

The safety means may also comprise means for determining whether the indicia 24 responded to the UV light beam. The controllers 50, 44 are operatively connected to the UV light sources 26, 42 for energizing the UV light sources at low duty cycles when the indicia has not responded to the UV light beam, and at high duty cycles when the indicia has responded to the UV light beam. Rather than changing the duty cycle of the UV light sources, the controllers could merely reduce the UV output power. The determining means preferably comprises a visible light source 56 operative for illuminating the UV light-responsive indicia with a visible light beam, and a comparator 58 for comparing the visible light beam and the UV light beam returning from the UV light-responsive indicia.

In another embodiment of the safety means, the controllers 50, 44 are operatively connected to the UV light sources, and determine whether the UV light-responsive indicia was successfully read, and deenergize the UV light sources upon a determination that the UV light-responsive indicia was not successfully read for a predetermined period of time. In addition, the controllers 50,44 may be operatively connected via a wireless transceiver 60 to a host 62, and energizes the UV light source only upon a command generated by the host 62 to increase safety. In addition, another safety measure involves turning the UV light source on when the housing is in contact with the UV light-responsive indicia. This can be determined by a pressure switch 66 on the housing or a proximity detector. One or more of the above-described safety measures may be utilized in a UV light-based electro-optical system such as reader 20 or imager 10.

For either system, the light returning from the UV light-responsive indicia may have the same wavelength as the UV light beam due to reflection from the UV light-responsive indicia, in which case the detector must be able to detect the reflected UV light. Alternatively, for either system, the light returning from the UV light-responsive indicia may have a different wavelength, e.g., visible light, as the UV light beam due to fluorescence by the UV light-responsive indicia, in which case the detector must be able to detect the returning visible light. Inks that fluoresce in the visible spectrum under UV light are known in the art, e.g., inks used for making so-called “black light” posters, and any of these inks can be used for making bar code symbols or markings to be read by either system. Further, some UV fluorescent inks are transparent and non-fluorescing to visible light, thus allowing a bar code symbol or marking to be provided which is invisible to human sight under normal lighting conditions. Such invisible bar code symbols could be used where a normal (i.e., human visible) bar code symbol is undesirable, either for appearance or for security reasons.

It is also possible that the UV light source not be within the housing, but instead, may be located externally of the window. In that case, the window may be designed to block reflected UV light and only permit the visible light to pass therethrough. It is also possible for a filter to be provided to block the reflected UV light in front of the focusing lens, or an optical coating can be provided on the focusing lens.

It will be understood that each of the elements described above, or two or more together, also may find a useful application in other types of constructions differing from the types described above.

While the invention has been illustrated and described as embodied in electro-optical reading systems, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. An arrangement for electro-optically reading ultraviolet (UV) light-responsive indicia, comprising:
a UV light source for generating a UV light beam having a wavelength shorter than visible light, and for illuminating the UV light-responsive indicia;
a detector for detecting light returning from the UV light-responsive indicia, and for generating an electrical signal indicative of the UV light-responsive indicia; and
safety means for reducing exposure to the UV light beam to within safe limits.

2. The arrangement of claim 1, and a housing for supporting the UV light source and the detector, and wherein the housing has a window.

3. The arrangement of claim 1, wherein the UV light source comprises one of a UV light emitting diode, a UV laser, and a mercury vapor lamp.

4. The arrangement of claim 1, and a scanner for sweeping the UV light beam across the UV light-responsive indicia, and wherein the detector is a photodiode.

5. The arrangement of claim 1, wherein the detector is an imaging array of photosensors operative for capturing light returning from the UV light-responsive indicia.

6. The arrangement of claim 1, wherein the light returning from the UV light-responsive indicia has the same wavelength as the UV light beam due to reflection from the UV light-responsive indicia.

7. The arrangement of claim 1, wherein the light returning from the UV light-responsive indicia has a different wavelength as the UV light beam due to fluorescence by the UV light-responsive indicia.

8. The arrangement of claim 2, wherein the safety means comprises means for determining an orientation of the housing, and a controller operatively connected to the UV light source for enabling the UV light source to generate the UV light only when the orientation is within a predetermined range of orientations.

9. The arrangement of claim 8, wherein the determining means comprises one of a tilt sensor and an accelerometer mounted in the housing.

10. The arrangement of claim 1, wherein the safety means comprises an optical filter for filtering the UV light beam to block harmful wavelengths of the UV spectrum below 400 nanometers.

11. The arrangement of claim 1, wherein the safety means comprises a shroud around the UV light source for blocking some of the UV light beam.

12. The arrangement of claim 1, wherein the safety means comprises means for determining whether the indicia responded to the UV light beam, and a controller operatively connected to the UV light source for energizing the UV light source at a low duty cycle when the indicia has not responded to the UV light beam, and at a high duty cycle when the indicia has responded to the UV light beam.

13. The arrangement of claim 1, wherein the safety means comprises means for determining whether the indicia responded to the UV light beam, and a controller operatively connected to the UV light source for reducing output power of the UV light source when the indicia has responded to the UV light beam.

14. The arrangement of claim 12, wherein the determining means comprises a visible light source operative for illuminating the UV light-responsive indicia with a visible light beam, and means for comparing the visible light beam and the UV light beam returning from the UV light-responsive indicia.

15. The arrangement of claim 1, wherein the safety means comprises a controller operatively connected to the UV light source, for determining whether the UV light-responsive indicia was successfully read, and for deenergizing the UV light source upon a determination that the UV light-responsive indicia was not successfully read for a predetermined period of time.

16. The arrangement of claim 1, wherein the safety means comprises a controller operatively connected to the UV light source, for determining whether the UV light-responsive indicia was successfully read, and for deenergizing the UV light source upon a determination that the UV light-responsive indicia was not successfully read and a predetermined UV power level was not reached for a predetermined period of time.

17. The arrangement of claim 1, wherein the safety means comprises a controller operatively connected to the UV light source and a host, for energizing the UV light source upon a command generated by the host.

18. The arrangement of claim 2, wherein the safety means energizes the UV light source upon a determination that the housing is in a predetermined physical relationship with the UV light-responsive indicia.

19. An arrangement for electro-optically reading ultraviolet (UV) light-responsive indicia, comprising:
means for generating a UV light beam having a wavelength shorter than visible light, and for illuminating the UV light-responsive indicia;
means for detecting light returning from the UV light-responsive indicia, and for generating an electrical signal indicative of the UV light-responsive indicia; and
safety means for reducing exposure to the UV light beam to within safe limits.

20. A method of electro-optically reading ultraviolet (UV) light-responsive indicia, comprising the steps of:
generating a UV light beam having a wavelength shorter than visible light, and illuminating the UV light-responsive indicia;
detecting light returning from the UV light-responsive indicia, and generating an electrical signal indicative of the UV light-responsive indicia; and
reducing exposure to the UV light beam to within safe limits.

21. The method of claim 20, wherein the generating and detecting steps are performed in a housing having a window.

22. The method of claim 20, wherein the generating step is performed by one of a UV light emitting diode, a UV laser, and a mercury vapor lamp.

23. The method of claim 20, and sweeping the UV light beam across the UV light-responsive indicia, and wherein the detecting step is performed by a photodiode.

24. The method of claim 20, wherein the detecting step is performed by an imaging array of photosensors operative for capturing light returning from the UV light-responsive indicia.

25. The method of claim 20, wherein the light returning from the UV light-responsive indicia has the same wavelength as the UV light beam due to reflection from the UV light-responsive indicia.

26. The method of claim 20, wherein the light returning from the UV light-responsive indicia has a different wavelength as the UV light beam due to fluorescence by the UV light-responsive indicia.

27. The method of claim 20, and determining an orientation of the housing, and generating the UV light only when the orientation is within a predetermined range of orientations.

28. The method of claim 27, wherein the determining step is performed by one of a tilt sensor and an accelerometer mounted in the housing.

29. The method of claim 20, and filtering the UV light beam to block harmful wavelengths of the UV spectrum below 400 nanometers.

30. The method of claim 20, and blocking some of the UV light beam.

31. The method of claim 20, and determining whether the indicia responded to the UV light beam, and energizing the UV light beam at a low duty cycle when the indicia has not responded to the UV light beam, and at a high duty cycle when the indicia has responded to the UV light beam.

32. The method of claim 20, and determining whether the indicia responded to the UV light beam, and reducing output power of the UV light beam when the indicia has responded to the UV light beam.

33. The method of claim 32, wherein the determining step is performed by illuminating the UV light-responsive indicia with a visible light beam, and comparing the visible light beam and the UV light beam returning from the UV light-responsive indicia.

34. The method of claim 20, and determining whether the UV light-responsive indicia was successfully read, and deenergizing the UV light beam upon a determination that the UV light-responsive indicia was not successfully read for a predetermined period of time.

35. The method of claim 20, and determining whether the UV light-responsive indicia was successfully read, and deenergizing the UV light beam upon a determination that the UV light-responsive indicia was not successfully read and the UV output power of the UV light beam did not reach a predetermined value for a predetermined period of time.

36. The method of claim 20, and energizing the UV light beam upon a command generated by a host.

37. The method of claim 21, and energizing the UV light beam when the housing is in a predetermined physical relationship with the UV light-responsive indicia.
